(19) United States
(12) Patent Application Publication
(10) Pub. No.: US 2008/0165129 A1
(43) Pub. Date: Jul. 10, 2008

(54) COMPUTER MOUSE CAPABLE OF SWITCHING BETWEEN A LEFT-HANDED MODE AND A RIGHT-HANDED MODE

(75) Inventors: JIA-HE TANG, Shenzhen (CN); LING LIU, Shenzhen (CN); WEN-HAW TSENG, Tu-Cheng (TW); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO.,LTD., ShenZhen City (CN); HON HAI PRECISION INDUSTRY CO., LTD., Tu-Cheng (TW)

(21) Appl. No.: 11/874,924

(22) Filed: Oct. 19, 2007

(30) Foreign Application Priority Data
Jan. 4, 2007 (CN) 200710200004.4

(51) Int. Cl. G06F 3/033

(52) U.S. Cl. 345/163

(57) ABSTRACT

A computer mouse capable of switching between a left-handed mode and a right-handed mode is provided. The mouse includes a first transistor-circuit, a second transistor-circuit, and a control switch. The control switch has at least a first state and a second state. When the control switch is in the first state, it enables the first transistor-circuit, and thus the left button signals and the right button signals are transmitted to a left-button input pin and a right-button input pin of an integrated circuit chip respectively. When the control switch is in the second state, it enables the second transistor-circuit, and thus the left button signals and the right button signals are transmitted to the right-button input pin and the left-button input pin of the integrated circuit chip respectively.

### BACKGROUND

1. Technical Field

The present invention relates to a computer mouse, and particularly to a computer mouse capable of switching between a left-handed mode and a right-handed mode.

2. General Background

As is well known, computers are popular devices, many people uses computers for extended periods, and a computer mouse is an important accessory of the computer. Usually, one of the default settings of the mouse is for right-handed mode. In this mode, pressing or clicking the “left” mouse button causes the computer to select and change the state of the cursor on the display, pressing or clicking the “right” mouse button causes context related menu to be displayed.

However, mouse usage may cause carpal tunnel syndrome and other muscle sickness, so changing the hand to use the mouse now and then, will rest the muscles. To execute the function of the “left” mouse button the index finger is usually used and to execute the function of the “right” mouse button the middle finger is usually used. When changing hands to operate the mouse, it is necessary that change the mouse right-handed mode. In the right-handed mode, pressing or clicking the “left” mouse button context related menu to be displayed, pressing or clicking the “right” mouse button causes the computer to select and change the state of the cursor on the display.

A common method to switch the mouse between the left-handed mode and the right-handed mode is by software such as in the control panel of the Windows Operating system. Another method is to utilize a program to execute the mouse button switching. However, it is inconvenient because it needs additional time and knowledge to implement.

U.S. Pat. No. 6,072,471, discloses an ambidextrous upright computer mouse. However, the mouse disclosed in this patent needs to add a new set of buttons, when the mouse is a left-handed mouse, the mouse chooses a set of left-handed buttons to work, and when the mouse is a right-handed mouse, the mouse chooses a set of right-handed buttons to work.

According to this, it is necessary to provide a mouse to overcomes the above-identified deficiencies.

### SUMMARY

A computer mouse provided in the preferred embodiment of the present invention uses hardware to switch between a left-handed mode and a right-handed mode. The mouse includes a left button, a right button, an integrated circuit chip, a control switch, a first transistor-circuit, and a second transistor-circuit. The first transistor-circuit and the second transistor-circuit all include a plurality of transistors. The integrated circuit chip includes a left-button input pin and a right-button input pin, and is configured for receiving and processing button signals from the left button and the right button. The control switch is operable to switch between a first state and a second state. When the control switch is in the first state, the first transistor-circuit is enabled and transmits left button signals to the left-button input pin of the integrated circuit chip and transmits the right button signals to the right-button input pin of the integrated circuit chip. When the control switch is in the second state, the second transistor-circuit is enabled and transmits the left button signals to the right-button input pin and transmits the right button signals to the left-button input pin of the integrated circuit chip respectively.

With such a configuration, the control switch can be operated to switch the mouse between the left-handed mode and the right-handed mode easily, and the mouse only need one set of buttons. The drawbacks existed in the related art are accordingly avoided.

Other advantages and novel features of the present mouse suitable both for left-handed and right-handed users will become more apparent from the following detailed description of the preferred embodiments when taken in conjunction with the accompanying drawings.

### BRIEF DESCRIPTION OF THE DRAWINGS

FIG. 1 is an aspect view of a computer mouse capable of switching between a left-handed mode and right-handed mode;

FIG. 2 is a block diagram of the mouse in accordance with a preferred embodiment of the present invention; and

FIG. 3 is a circuit diagram of FIG. 2.

### DETAILED DESCRIPTION OF THE EMBODIMENT

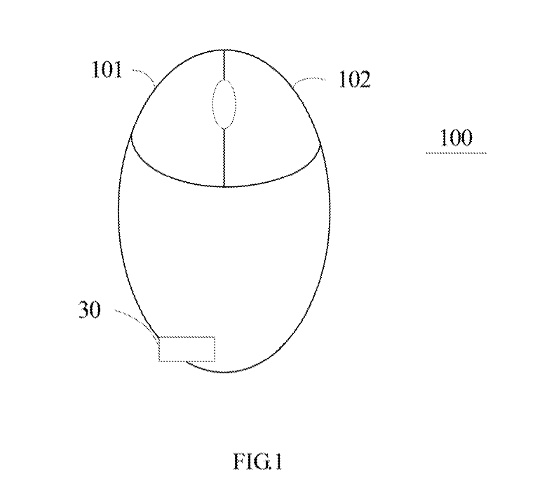

FIG. 1 is an aspect view of a computer mouse 100 capable of switching between a left-handed mode and a right-handed mode in accordance with a preferred embodiment of the present invention. The mouse 100 is equipped with a left button 101, a right button 102, and a control switch 30. The control switch 30 could be configured at any suitable place of the mouse 100, such as at a left side, a right side, or an end of the mouse 100. For example, in the preferred embodiment as shown in FIG. 1, the control switch 30 is placed at a bottom end of the mouse 100. The control switch 30 is provided for manually switching the mouse 100 between a left-handed mode and a right-handed mode conveniently.

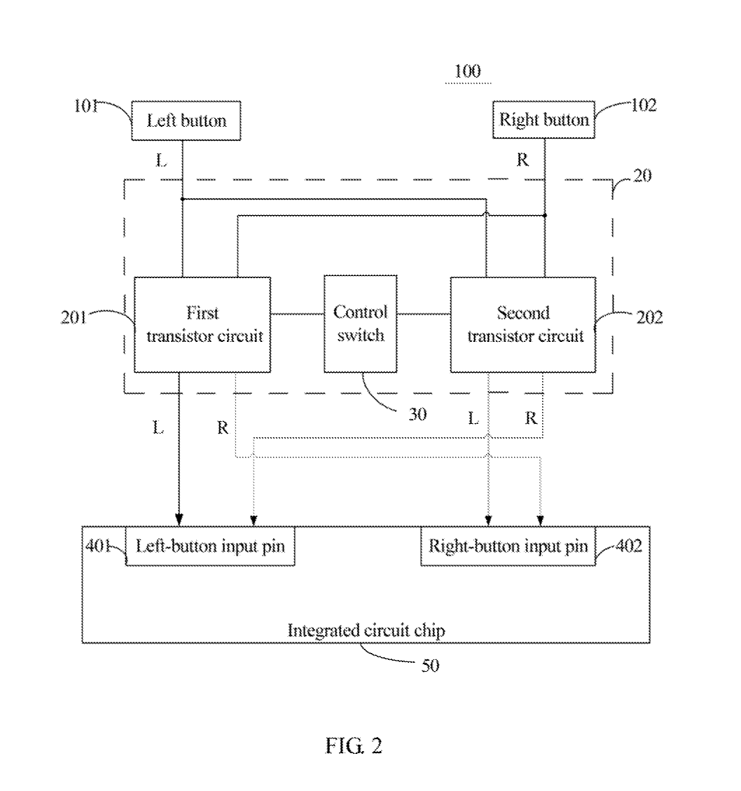

FIG. 2 is a block diagram of the mouse in accordance with a preferred embodiment of the present invention. The mouse 100 includes an integrated circuit chip 50 placed inside of the mouse 100. The integrated circuit chip 50 includes a left-button input pin 401 and a right-button input pin 402. The integrated circuit chip 50 converts signals inputted through the left button pin 401 and the right button pin 402 to a digital data stream that is sent to the computer. The mouse 100 further includes a button switching circuit 20 connected between the integrated circuit chip 50 and the buttons 101,102. The button switching circuit 20 includes a first transistor-circuit 201, a second transistor-circuit 202, and the control switch 30. The transistor circuits 201, 202 are connected in parallel between the button 101,102 and the integrated circuit chip 50. The transistor circuits 201, 202 connect the buttons 101,102 to the button input pins 401,402 of the integrated circuit chip 50 correspondingly. Each of the transistor-circuits 201 and the 202 can be in an enabled state and a disabled state. The states of the transistor-circuits 201,202 are controlled by the control switch 30.

The control switch 30 has at least a first state and a second state. When the control switch 30 is in the first state, the control switch 30 connects with the first transistor-circuit 201, and consequently enables the first transistor-circuit 201 and disables the second transistor-circuit 202. When the first transistor-circuit is enabled, the first transistor-circuit 201 connects the left button 101 to the left-button input pin 401 and connects the right button 102 to the right-button input pin 402. As a result, left button signals L produced by pressing the left button 101 are transmitted to the left-button input pin 401 of the integrated circuit chip 50, and right button signals R produced by pressing the right button 102 are transmitted to the right-button input pin 402 of the integrated circuit chip 50. When the control switch 30 is in the second state, the control switch 30 connects with the second transistor-circuit 202, and consequently enables the second transistor-circuit 202 and disables the first transistor-circuit 201. When the second transistor-circuit 202 is enabled, the second transistor-circuit 202 connects the left button 101 to the right-button input pin 402 and connects the right button 102 to the left-button input pin 401. As a result, the left button signals L produced by pressing the left button 101 are transmitted to the right-button input pin 402 of the integrated circuit chip 50, and the right button signals R produced by pressing the right button 102 are transmitted to the left-button input pin 401 of the integrated circuit chip 50.

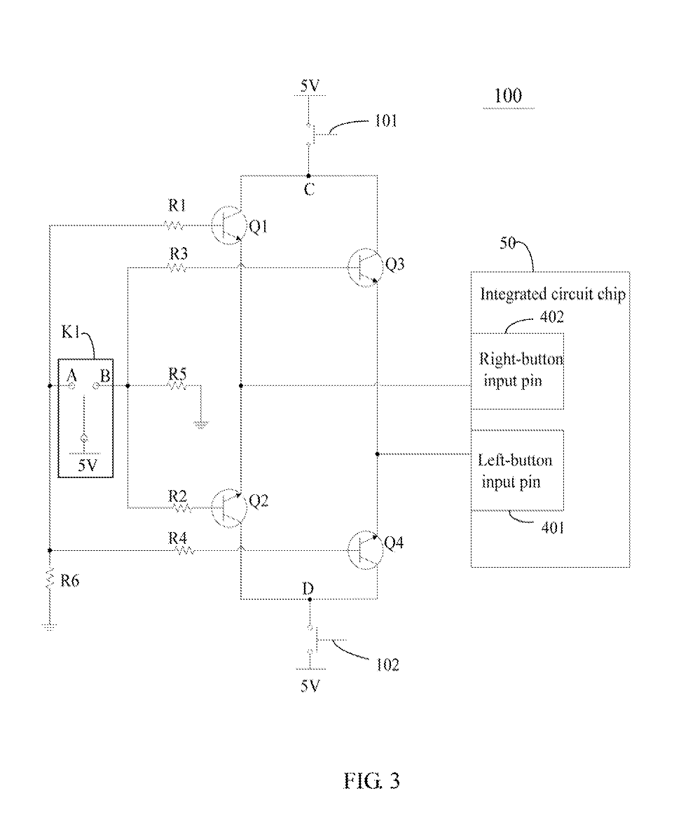

FIG. 3 is a circuit diagram of FIG. 2. The control switch 30 is typically a single pole double throw (SPDT) switch k1. The SPDT switch k1 is connected to a 5V voltage source and the single pole of the SPDT switch k1 can be switched between two contact points (symbolically expressed as contact point B and contact point A in FIG. 3), thus switching the control switch 30 to be in the first state or in the second state. In other cases, the control switch 30 can be a digital switch or any other suitable types of switches.

The first transistor-circuit 201 includes negative-positive-negative (NPN) bipolar junction transistors (BJTs) Q3, Q2 and resistors R3, R2. A base of the BJT Q3 connects with the contact point B via the resistor R3, and a base of the BJT Q2 connects with the contact point B via the resistor R2. An out terminal C of the left button 101 connects with a collector of the BJT Q3, and the left-button input pin 401 of the integrated circuit chip 50 connects with an emitter of the BJT Q3. An out terminal D of the right button 102 connects with a collector of the BJT Q2, and the right-button input pin 402 of the integrated circuit chip 50 connects with an emitter of the BJT Q2.

The second transistor-circuit 202 includes two NPN BJTs Q1, Q4 and two resistors R1, R4. A base of the Q1 connects with the contact point A via the resistor R1, and a base of the BJT Q4 connects with the contact point A via the resistor R4. The out terminal C of the left button 101 connects with a collector of the BJT Q1, and the right-button input pin 402 of the integrated circuit chip 50 connects with an emitter of the BJT Q1. The out terminal D of the right button 102 connects with a collector of the BJT Q4, and the left-button input pin 401 of the integrated circuit chip 50 connects with an emitter of the BJT Q4.

When the single pole of the SPDT switch k1 is connected to the contact point B, and the SPDT switch K1 is in the first state, the contact point B is at a high voltage level (i.e., 5 v), and enables the BJTs Q2 and Q3. At the same time, the contact point A is grounded via the resistor R6, causing the BJTs Q1 and Q4 to be in the disabled state. Thus, the left button 101 is connected to the left-button input pin 401 of the integrated circuit chip 50 via the BJT Q3, and the right button 102 is connected to the right-button input pin 402 of the integrated circuit chip 50 via the BJT Q2. The left button signals L are transmitted to the left-button input pin 401 through the BJT Q3, and the right button signals R are transmitted to the right-button input pin 402 through the BJT Q2. The mouse 100 is accordingly in the right-handed mode.

When the single pole of the switch K1 is connected to the contact point A, and the switch K1 is in the second state, the contact point A is at the high voltage level (i.e., 5 v), and enables the BJTs Q1 and Q4. At the same time, B is grounded via resistor R5, causing the BJTs Q2 and Q3 to be in the disabled state. Thus, the left button 101 is connected to the right-button input pin 402 of the integrated circuit chip 50 via the BJT Q1, and the right button 102 is connected to the left-button input pin 401 of the integrated circuit chip 50 via the BJT Q4. The left button signals L are transmitted to the right-button input pin 402 via the BJT Q1, and the right button signals R are transmitted to the left-button input pin 401 via the BJT Q4. The mouse 100 is accordingly changed from the right-handed mode to the left-handed mode.

In other embodiments of the present invention, the BJTs Q1, Q2, Q3 and Q4 can be replaced by MOSFETs (metal-oxide-semiconductor field-effect transistors).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer mouse capable of switching between a left-handed mode and a right-handed mode, the computer mouse comprising:
a left button, when being pressed, producing left button signals;
a right button, when being pressed, producing right button signals;
an integrated circuit chip comprising:
a left-button input pin and a right-button input pin, which is configured for receiving and processing button signals from the left button and the right button respectively;
a control switch operable to switch between a first state and a second state;
a first transistor-circuit; and
a second transistor-circuit;
wherein, the first transistor-circuit and the second transistor-circuit comprise a plurality of transistors; wherein, when the control switch is in the first state, the first transistor-circuit is enabled and transmits left button signals to the left-button input pin of the integrated circuit chip and transmits the right button signals to the right-button input pin of the integrated circuit chip; and
when the control switch is in the second state, the second transistor-circuit is enabled and transmits the left button signals to the right-button input pin and transmits the right button signals to the left-button input pin of the integrated circuit chip respectively.

2. The computer mouse according to claim 1, wherein the first transistor-circuit and the second transistor-circuit are both constituted by NPN bipolar junction transistors (BJTs).

3. The computer mouse according to claim 1, wherein the first transistor-circuit and the second transistor-circuit are both constituted by NPN metal oxide semiconductor field effect transistors (MOSFETs).

4. The computer mouse according to claim 2, wherein the first transistor-circuit comprises a first BJT and a second BJT, a base of the first BJT is controlled by the control switch, a collector of the first BJT is connected to the left button of the mouse, and an emitter of the first BJT is connected to the left-button input pin of integrated circuit chip; a base of the second BJT is controlled by the control switch, a collector of the second BJT is connected to the right button of mouse, and an emitter of the second BJT is connected to the right-button input pin of the integrated circuit chip.

5. The computer mouse according to claim 4, wherein the control switch connects the bases of the first BJT and the second BJT to a high voltage level when in the first state.

6. The computer mouse according to claim 2, wherein the second transistor-circuit comprises a first BJT and a second BJT, a base of the first BJT is controlled by the control switch, a collector of the first BJT is connected to the left button of the mouse, and an emitter of the first BJT is connected to the right-button input pin of integrated circuit chip; a base of the second transistor is controlled by the control switch, a collector of the second BJT is connected with the right button of mouse, and an emitter of the second BJT is connected to the left-button input pin of the integrated circuit chip.

7. The computer mouse according to claim 6, wherein the control switch connects the bases of the first BJT and the second BJT to a high voltage level when in the second state.

8. The computer mouse according to claim 1, wherein the control switch is a single pole double throw (SPDT) switch.

9. The computer mouse according to claim 1, wherein the control switch is placed at a particular position of the mouse, and the particular position is selected from the group consisting of a left side, a right side and an end of the mouse.
